(19) United States
(12) Patent Application Publication
(10) Pub. No.: US 2025/0271000 A1
(43) Pub. Date: Aug. 28, 2025

(54) VENTILATION SYSTEM FAN SCROLL

(71) Applicant: Broan-NuTone LLC, Hartford, WI (US)

(72) Inventors: Robert Woodruff, Hartford, WI (US); Jesse Hollingsworth, Hartford, WI (US); Anup Nikam, Germantown, WI (US); Luis Esparza, Baja California (MX)

(21) Appl. No.: 18/585,704

(22) Filed: Feb. 23, 2024

(51) Int. Cl. F04D 29/42; F04D 25/08; F24F 7/013

(52) U.S. Cl. CPC F04D 29/4226; F04D 25/08; F04D 29/422; F24F 7/013

(57) ABSTRACT

A ventilation fan configured to be positioned adjacent to a room of a building structure to ventilate the room is disclosed. The ventilation fan has a fan housing with an external wall defining an internal region. A blower is configured to be located in the internal region. A tongue extends from one of the fan housing and the blower and a slot is defined by one of the fan housing and the blower. The slot configured to receive the tongue to secure the blower to the fan housing.

### BACKGROUND

Conventional ventilation fans, such as those typically installed in a room of a building structure (e.g. a bathroom) can draw air from within an area of the room, through the fan and exhaust the air to another location, such as through a vent in the gable or roof of a home or other building structure. Many conventional ventilation fans include a fan housing positioned within or adjacent an aperture formed in a wall or ceiling of the room and a blower secured to the fan housing by inserting it into the housing in one motion and securing the blower to the fan housing by fasteners. Keeping the fastener holes of the blower aligned with those of the fan housing during installation of the fasteners can be challenging. Therefore, a need exists for a ventilation fan that allows for easier securing of the blower to the fan housing and/or use of fewer fasteners to simplify assembly and reduce assembly time.

Conventional ventilation fans, such as the one described above, also use a duct connector that has a rectangular input (to match a rectangular opening in the fan housing) and a round output to facilitate connection with a typical round ducting used to direct outflow to the gable, roof or other portion of the building in which air is to be exhausted. Blowers are typically mounted in the fan housing with the blower outlet located adjacent to, and often pressed against, the fan housing outlet aperture. Airflow leakage often occurs at the interface between the blower and the fan housing. Similarly, the duct connector is typically mounted to the exterior of the fan housing adjacent the fan housing outlet aperture and likewise experiences airflow leakage. Therefore, a need exists for a ventilation fan that facilitates a better interface between the blower, the fan housing and the duct connector to reduce airflow leakage.

A full discussion of the features and advantages of the present disclosure is deferred to the following detailed description, which proceeds with reference to the accompanying drawings.

The description provided in the background section should not be assumed to be prior art merely because it is mentioned in or associated with the background section.

### SUMMARY

A ventilation fan configured to be positioned adjacent to a room of a building structure to ventilate the room is disclosed, the ventilation fan has a fan housing with an external wall defining an internal region; a blower configured to be located in the internal region; a tongue extending from one of the fan housing and the blower; and a slot is defined by one of the fan housing and the blower, the slot configured to receive the tongue to secure the blower to the fan housing. The blower can have a scroll and a scroll mounting plate, and the slot can be defined in the scroll mounting plate. The ventilation fan can have a second tongue and a third tongue. The ventilation fan can define a second slot and a third slot. The tongue can have a proximal end at the fan housing and a distal end spaced from the fan housing, and the scroll mounting plate can sit between the tongue distal end and the external wall when the blower is secured to the fan housing. The scroll mounting plate can have an car extending beyond the perimeter of the scroll and the slot can define the car. The blower can be secured to the fan housing by sliding the scroll mounting plate under the tongue.

A ventilation fan is configured to be positioned adjacent to a room of a building structure to ventilate the room and the ventilation fan has a fan housing comprising an external wall defining an internal region, a fan housing inlet to the internal region and a fan housing outlet from the internal region; a blower configured to be located in the internal region, the blower having a scroll defining a blower inlet through which the blower is configured to draw air and a blower outlet through which the blower is configured to expel air, the blower outlet defining a blower outlet bevel; and an outlet seat between the blower outlet and the fan housing outlet, the outlet seat defining an aperture complementing the shape of the blower outlet and defining an outlet seat bevel; wherein the blower outlet bevel is configured to engage the outlet seat bevel. The outlet seat bevel can complement the blower outlet bevel. The ventilation fan can also have a duct connector that defines the outlet seat. The outlet seat can have a sleeve configured to extend into the fan housing outlet and the outlet seat bevel can extends into the sleeve. The outlet seat can have a plate defining the outlet seat aperture and a sleeve extending from the plate at the outlet seat aperture, wherein the sleeve comprises at least part of the outlet seat bevel, and the outlet seat bevel complements the blower outlet bevel. The plate of the outlet seat can be secured to the fan housing. A duct connector can be secured to the exterior of the fan housing, wherein the outlet seat has a sleeve configured to extend into the fan housing outlet and contact the duct connector outside of the fan housing.

A method for assembling a ventilation fan having a fan housing defining an internal region, and a blower, the method comprising the steps of: (a) moving the blower in a first direction toward the fan housing to place the blower into the internal region; (b) moving the blower a second direction, generally perpendicular to the first direction to secure the blower to the housing. The fan housing can comprise a tongue and the blower can comprise a slot and step (a) can further include locating the slot around the tongue. The tongue can extend from the fan housing into the internal region and step (a) can further include moving the blower in the first direction until the blower contacts the fan housing. Step (b) can further include moving the blower in the second direction until the blower is under the tongue. The blower can have an ear in which the slot is defined and step (b) can further include moving the blower in the second direction until the ear is between the tongue and the fan housing. The tongue can extend from the fan housing at a tongue proximal end and extend to a tongue distal end and step (b) can include moving the blower in the second direction until the ear contacts the tongue proximal end.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a perspective view of a ventilation system of the present disclosure.

FIG. 2A is a top view of the ventilation system of FIG. 1.

FIG. 2B is the view of FIG. 2A with the scroll of the blower removed to show the scroll mounting plate.

FIG. 2C is the view of FIG. 2A with the blower, including the scroll mounting plate, removed.

FIG. 2D is an exploded view of the scroll, the scroll mounting plate and a portion of the fan housing of FIG. 1.

FIG. 3A is a perspective view of a portion of the fan housing of FIG. 2D.

FIG. 3B is a perspective view of the scroll mounting plate secured to a portion of the fan housing.

FIG. 3C is a perspective view of the scroll mounting plate located over a portion of the fan housing in a first position;

FIG. 3D is a perspective view of the scroll mounting plate located over a portion of the fan housing in a second position;

FIG. 4A is a perspective, exploded view of the scroll, the blower outlet seat and the duct connector of the ventilation system of FIG. 1.

FIG. 4B is a side, exploded view of the scroll and the blower outlet seat.

FIG. 4C is a perspective, exploded view of the scroll and the blower outlet seat.

FIG. 4D is a top cross-sectional view of the interface between the scroll, the scroll interface and the fan housing.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

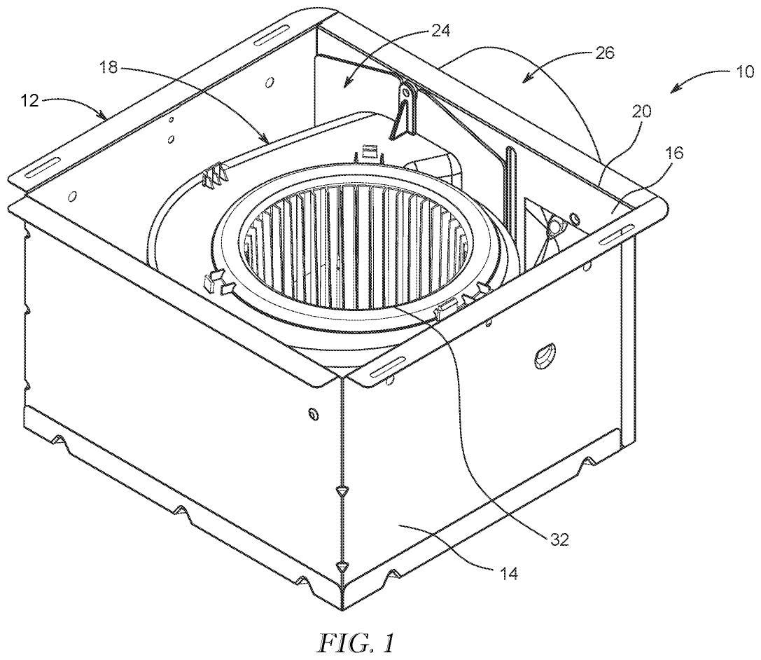

FIG. 1 depicts one embodiment of a ventilation fan 10 in accordance with the present disclosure. The ventilation fan 10 is configured to be positioned in a room of a building structure (not depicted) to provide ventilation for the room of the building structure. For example, the ventilation fan 10 may be positioned in a ceiling panel (not shown) of the room and aligned with a cutout in the ceiling panel to selectively ventilate the room. The ventilation fan 10 includes a fan housing 12 with an external wall structure 14 that defines an internal region 16. A blower 18 is located in the internal region 16 of the fan housing 12. The external wall structure defines an inlet 20 through which air can be drawn and an outlet 22 through which air can be expelled. A blower outlet seat 24 is located at the fan housing outlet 22 between the blower 18 and the fan housing 12. The fan housing inlet 20 is cooperatively shaped and dimensioned to align with the cutout formed in the ceiling of the room of the building structure. A duct connector 26 is located on the exterior of the fan housing 12 at the fan housing outlet 22 to receive exhaust air from the blower 18 and direct that exhaust air to exhaust ducting (not shown).

The fan housing 12 can be formed of any material known to those skilled in the art capable of withstanding varying temperatures, namely to withstand any heat radiated and/or conducted from the blower 18 and/or other components while providing structural integrity to the ventilation fan 10. In some embodiments, the fan housing 12 is formed of sheet metal, but could instead be formed of a ceramic or a polymer having a relatively high melting temperature and/or glass transition temperature. The fan housing 12 can have any shape, including a box-like or cubical shape, a hemi-spherical shape, a spherical shape, a pyramidal shape, and the like. The fan housing 12 can form a base or frame for the ventilation fan 10, thereby providing points and areas of attachment for other components of the ventilation fan 10.

In the depicted embodiment, the blower 18 is a centrifugal fan including a motor (not depicted) and a bladed rotor 28 that is configured to rotate about an axis and move air from the fan housing inlet 20 to the fan housing outlet 22 to provide ventilation to the room. However, other types of blower assemblies can be employed as desired. The blower 18 also includes a scroll 30 that partially encases the bladed rotor 28 and defines a blower inlet 32, through which the blower 18 draws air, and a blower outlet 34 through which the blower 18 exhausts air. A scroll mounting plate 36 extends across the bottom of the scroll 30 to substantially close the bottom of the scroll 30 except for a motor aperture 38 to accommodate portions of the blower motor.

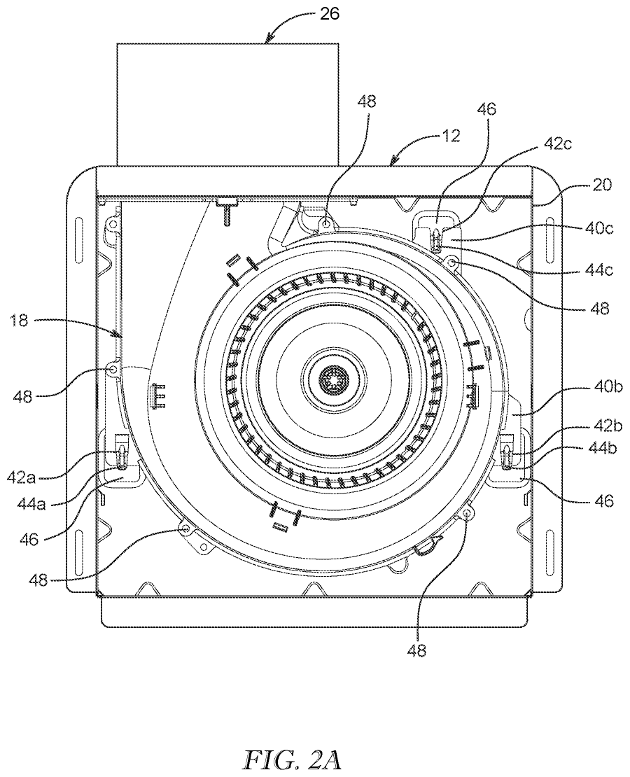

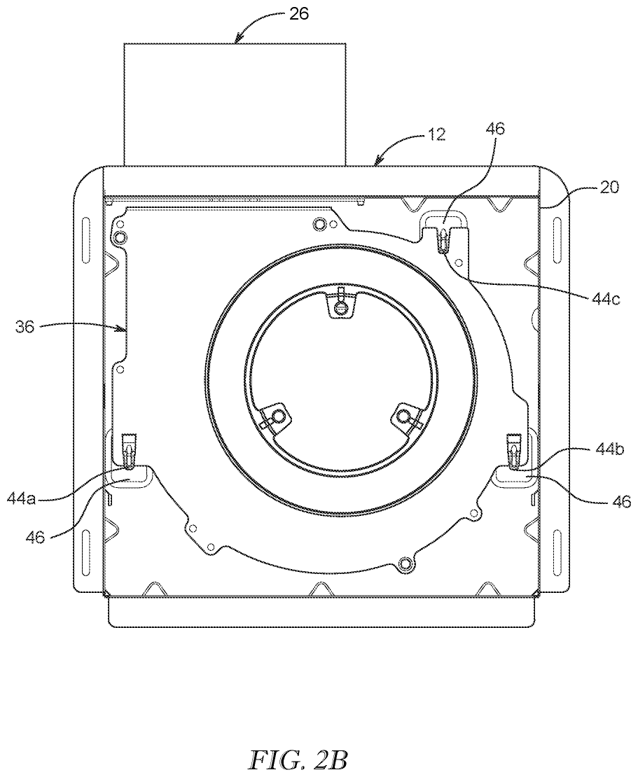

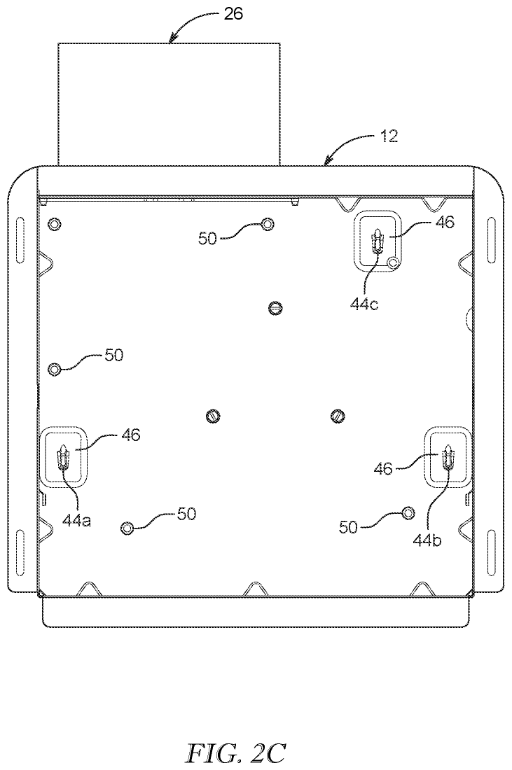

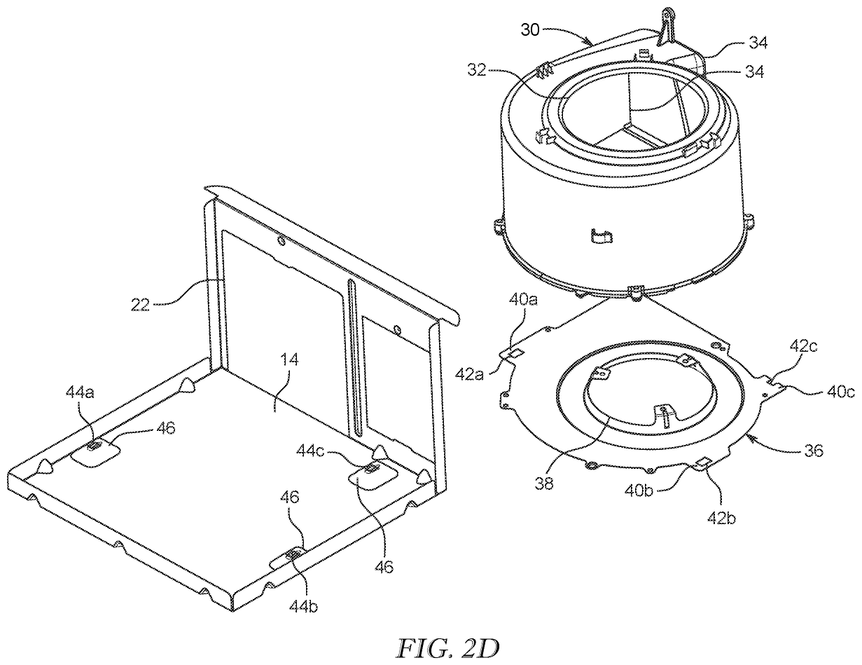

The depicted scroll mounting plate 36 has three ears 40a, 40b and 40c (collectively referenced as ears 40) that, as best depicted in FIG. 2A, each extend outward beyond the perimeter of the scroll 30. A greater or lesser number of ears 40 could be used in alternative embodiments. Each of the ears 40 defines a slot 42a, 42b and 42c (collectively referenced as slots 42). In the depicted embodiment, two of the slots 42a, 42b define apertures, while the third slot 42c defines a notch. Depending on the location of the ears in the fan housing 12, some, all or none of the slots 42c could be notches instead of apertures. In an alternative embodiment, the ears could be defined by the scroll 30 instead of the scroll mounting plate 36.

The bottom wall of the external wall structure 14 of the fan housing 12 comprises three tongues 44a, 44b and 44c (collectively referenced as tongues 44) extending from the fan housing 12 and protruding into the internal region 16 of the fan housing 12. The depicted embodiment includes optional pedestals 46 elevating the tongues 44, and as a result, elevating the blower 18, from the other portions of the external wall structure 14. In one embodiment, the fan housing 12 is constructed of sheet metal and the pedestals 46 and tongues 44 are formed from the sheet metal of the associated external wall structure 14. In this embodiment, the tongues 44 are stamped from the fan housing external wall structure 14 leaving an aperture in the fan housing external wall structure 14 adjacent to the tongue 44.

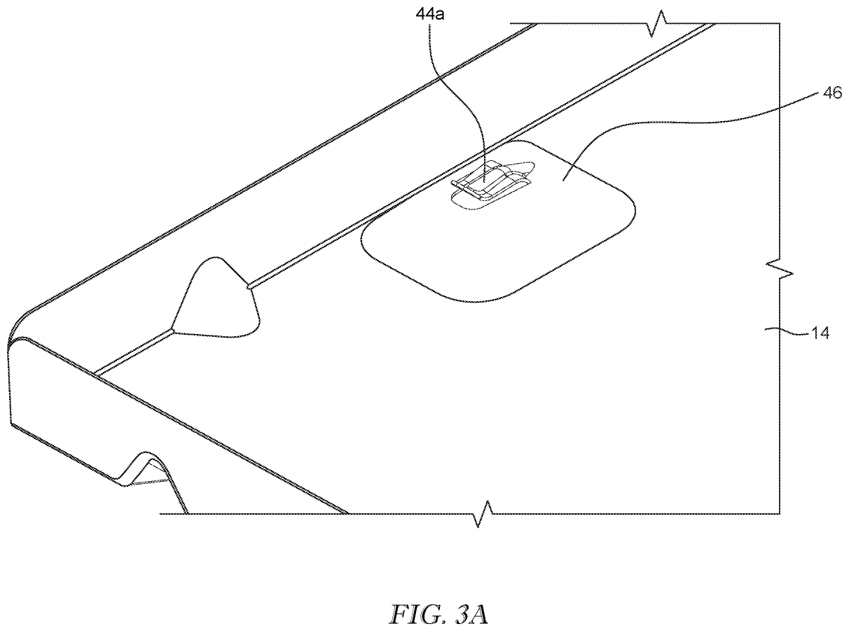

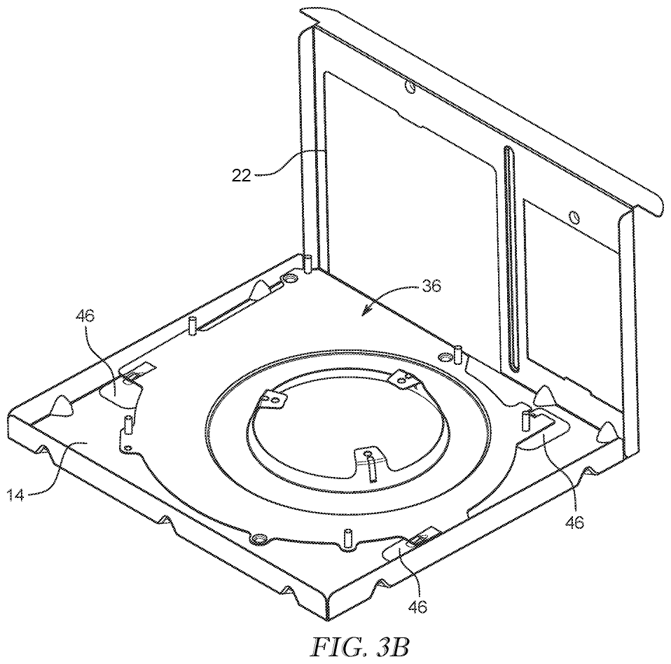

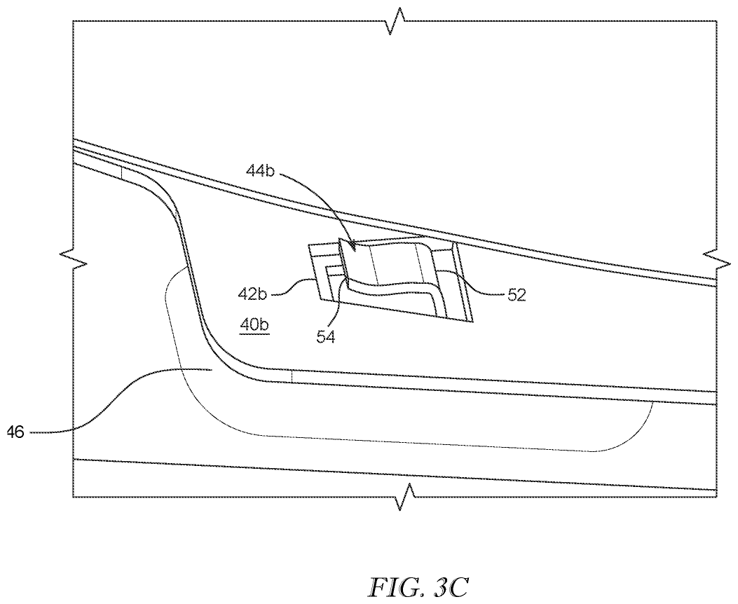

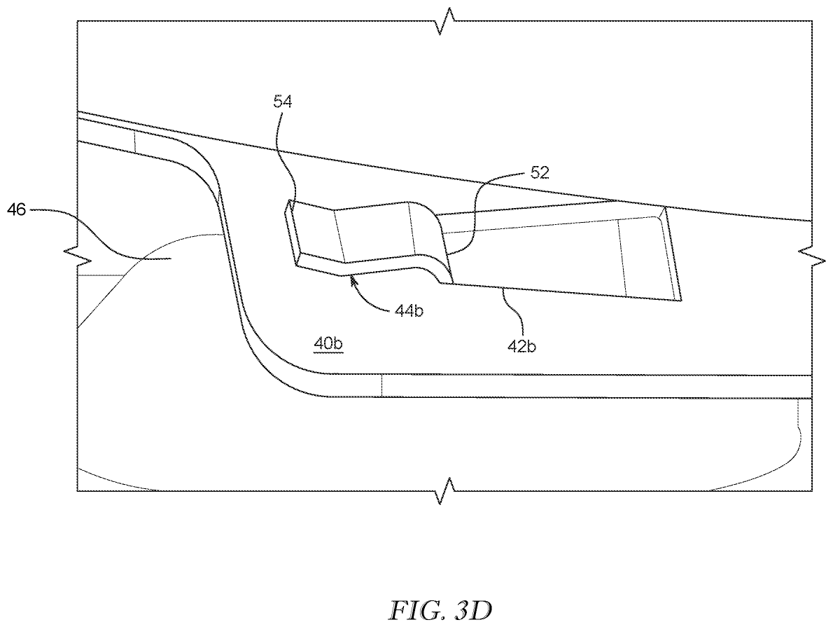

In one embodiment, the tongues 44 extend from the fan housing external wall structure 14 at a tongue proximal end 52 and continue to a tongue distal end 54 at which the tongue 44 terminates, as depicted, for example, in FIGS. 3C and 3D. The depicted tongues 44 define a curvature creating a downward curve between the proximal end 52 and the distal end 54 to create a downward force on objects slide between the tongue and the fan housing external wall structure 14.

To secure the blower 18 to the fan housing 12, the blower 18 is first inserted into the fan housing 12 using a first motion in a first direction toward the fan housing 12 until each of the slots 42 are located around an associated one of the tongues 44, as depicted in FIG. 3C. This can be accomplished by inserting the blower 18 into the fan housing 12 in the first direction until the ears 40 contact the fan housing external wall structure 14 (e.g. the pedestals 46 in the depicted embodiment). Then, the blower 18 is moved using a second motion in a second direction, generally perpendicular to the first direction, toward the tongue proximal ends 52 until the scroll mounting plate 36 is shifted so that the slots 42 are slide out from under the tongues 44 and the tongues extend over a solid portion of the scroll mounting plate 36, as depicted in FIG. 3D, as well as FIG. 2A. This can be accomplished by moving the blower 18 in the second direction until the edge of the slot 42 engages the tongue proximal end 52 and can travel no further. As a result of this second motion, the blower 18 is secured to the fan housing 12 and the force created by the curvature of the tongues 44 against the scroll mounting plate 36 keeps the blower 18 in place.

In this configuration, the blower 18 defines mounting holes 48 in either the scroll 30 or the scroll mounting plate 36 that are aligned with mounting holes 50 in the fan housing 12. Fasteners such as screws or rivets can then be inserted through one or more of the mounting holes 48, 50 more securely lock the blower in place relative to the fan housing 12.

Although the tongues 44 described and depicted in the embodiments disclosed herein are one possible fastener facilitating the securement of the blower 18 to the fan housing 12, alternative embodiments will be recognized by persons of ordinary skill in the art to allow installation of the blower 18 with the two-motion process described herein. In one non-limiting example, the tongues can be replaced by post extending from the fan housing 12 with an annular groove around the post configured to receive the scroll mounting plate after the slot is placed over the post. In this embodiment, the scroll mounting plate slots can optionally define keyhole shaped slots to accommodate the posts. Also, when tongues are used to facilitate this two-motion process, tongue configurations other than those shown and describe are also contemplated.

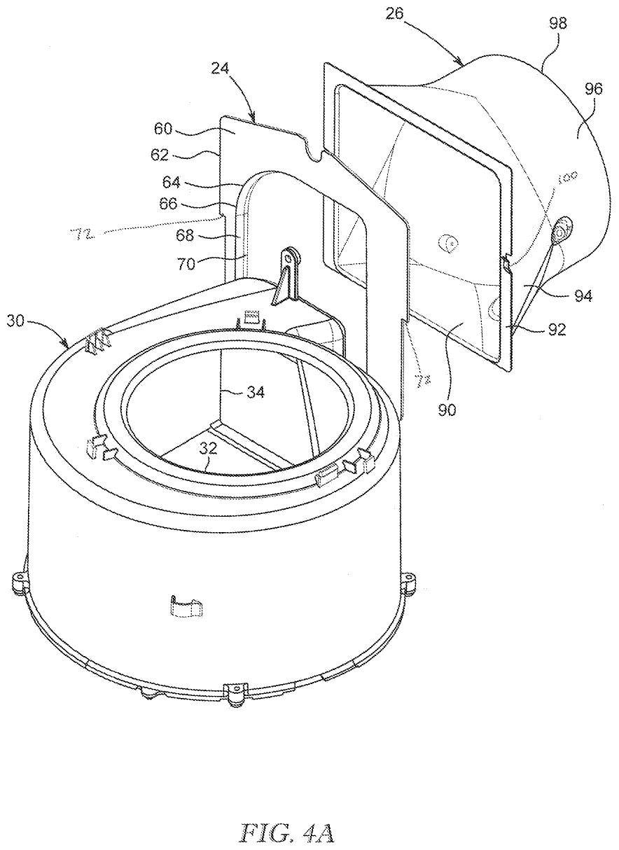

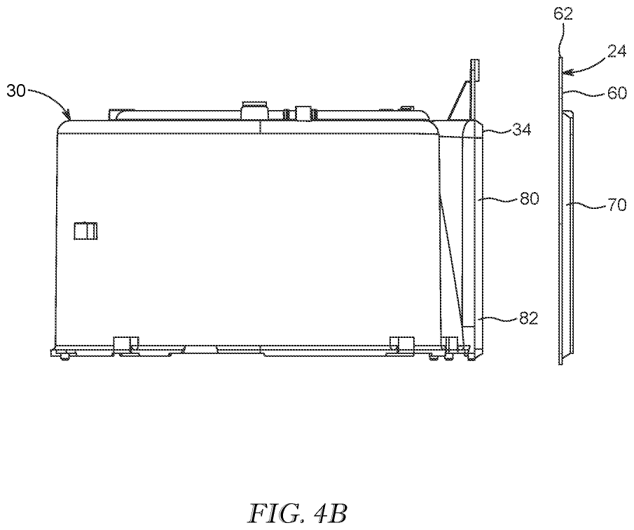

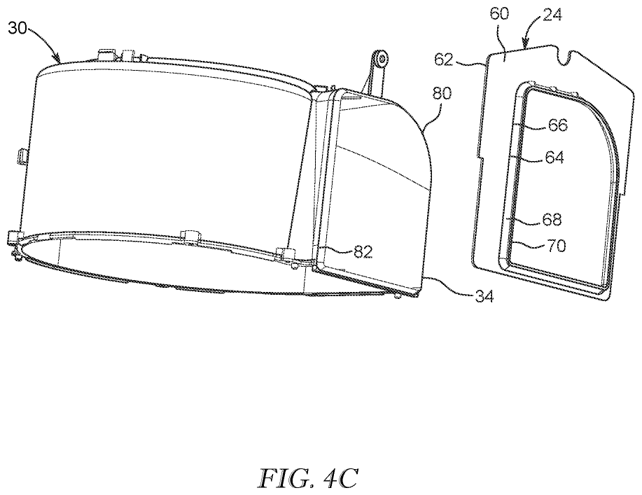

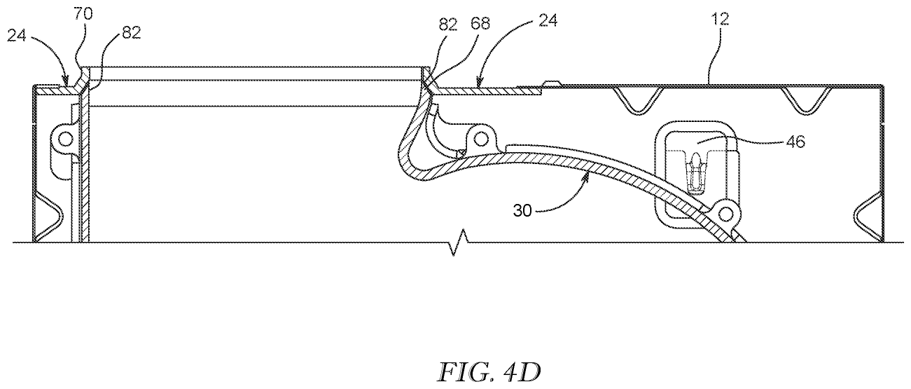

As depicted best in FIGS. 1 and 4A-D, the blower outlet seat 24 is located between the scroll outlet 34 and the fan housing 12. The blower outlet seat 24 is comprised of a plate 60 defining an external periphery 62 and an internal periphery 64. The internal periphery 64 defines a blower outlet seat aperture 66. The shape of the blower outlet seat aperture 66 complements the shape of the scroll outlet 34. The internal periphery 64 of the blower outlet seat 24 defines a bevel 68 across a thickness of the plate 60. Optionally, as depicted, a sleeve 70 can extend the beveled internal periphery 64 beyond the plate 60 on an exterior side 60a of the plate 60 to extend through the outlet aperture 22 of the fan housing 12. The bevel 68 can extend beyond the internal periphery 64 and along all or a portion of the sleeve 70. The size of the plate 60 can be used to cover a fan housing outlet 22 that is larger than the scroll outlet 34 such that different scrolls having different sized and shaped outlets can be accommodated into a single fan housing 12.

The scroll outlet 34 is defined by a peripheral wall 80. The peripheral wall 80 is shown as completely enclosing the scroll outlet 34, but in alternative embodiments, the peripheral wall 80 could only partially enclose the scroll outlet 34. At the scroll outlet 34, the scroll peripheral wall 80 defines a bevel 82. In one embodiment, the scroll peripheral wall bevel 82 complements the bevel 68 of the blower outlet seat 24, as best depicted in FIG. 4D. When the scroll 30 is installed in the fan housing 12 and the scroll peripheral wall bevel 82 engages the blower outlet seat bevel 68, as depicted in FIG. 4D, the scroll outlet 34 forms a seal with the blower outlet seat 24 and reduces or prevents air loss between the blower 18 and the fan housing 12. While the scroll peripheral wall bevel 82 and the blower outlet seat bevel 68 are depicted as straight, other complementary configurations are also contemplated with the goal of creating a seal between the two bevels 68, 82. The angle of the bevels 68, 82 can vary from the angle depicted and can also vary around the blower outlet seat aperture 68 and around the peripheral wall 80 of the scroll outlet 34.

In one embodiment, the duct connector 26 of FIG. 4A comprises a first connecting feature 100 depicted as a tongue. The first connecting feature 100 is located adjacent to the inlet aperture 90 of the duct connector 26. A second connecting feature 100 (hidden by the blower outlet seat 24) is located on the opposing side of the duct connector inlet aperture 90. The first and second connecting features 100 can engage with a first shoulder 72 and a second shoulder 72 extending outward from the blower outlet seat 24 to connect the duct connector 26 to the blower outlet seat 24 and to locate the duct connector 26 with respect to the blower outlet seat 24 for optimal air flow. The first and second connecting features 100 can comprises elements other than the depicted tongue 100.

In the depicted configuration in which the connecting features 100 are comprised of the tongue 100, each tongue 100 can be slide over the shoulder 72 of the blower outlet seat 24 such that the shoulder 72 is slide between the tongue 100 and the remainder of the duct connector 26. When the tongue 100 is slide over the shoulder 72 as far as it can go, the internal periphery 64 is aligned with the duct connector inlet aperture 90 for optimal flow. In one embodiment, once the duct connector 26 and the blower outlet seat 24 are connected and aligned in this manner, the duct connector 26 can be slide through the fan housing outlet 22 from the inside out until it abuts the fan housing and cannot proceed further. Connectors (e.g. screws, rivets, etc.) can then secure the blower outlet seat 24 and the duct connector 26 to the fan housing 12, pinching the duct connector 26 between the blower outlet seat 24 and the fan housing 12.

It will be understood that because the scroll peripheral wall bevel 82 extends into the blower outlet seat aperture 66, as depicted in FIG. 4D, the blower 18 cannot be installed with a single motion of lowering the blower 18 into the fan housing 12, as is done with some existing blowers. Instead, installation requires a first motion lowering the blower 18 into the fan housing 12 in a first direction, and then, in a second motion, moving the blower 18 in a second direction, laterally, such that the scroll outlet 34 moves into the blower outlet seat aperture 66 to engage the bevels 68, 82.

It will also be understood that the first motion of securing the blower 18 to the fan housing is the same as the first motion of engaging the scroll peripheral wall bevel 82 and the blower outlet seat bevel 68. Stated differently, by lowering the blower 18 into the fan housing 12, two different things are accomplished: (i) the first step of locating the blower slots 42 over tongues 44 of the fan housing 12, and (ii) the first step of engaging the scroll peripheral wall bevel 82 to the blower outlet seat bevel 68. Additionally, the second motion of securing the blower 18 to the fan housing 12 (i.e. moving the blower sideways) accomplishes both sliding the ears 40 under the tongues 44, and engaging the scroll peripheral wall bevel 82 with the blower outlet seat bevel 68.

The scroll 30 can be made of any know materials. The blower outlet seat 24 can likewise be made of any known materials. The scroll 30 and the blower outlet seat 24 can be made of the same materials or of different materials. In one embodiment, the scroll 30 and the blower outlet seat 24 are both made of polypropylene.

The depicted duct connector 26 is one of any of the typical, known duct connectors and defines an inlet aperture 90, with a flange 92 extending outwardly therefrom. The flange 92 engages with the fan housing 12 and facilitates securing the duct connector 26 to the fan housing 12. A transition region 94 extends from the flange 90 and transitions the duct connector 26 from a rectangular shape to a round shape. A round region 96 extends from the round end of the transition region 94 and forms a round outlet aperture 98. The external configuration of the blower outlet seat sleeve 70 preferably, complements the configuration of the inside of the duct connector inlet aperture 90 so that the two fit snuggly and create a seal there between.

In an alternative embodiment, not depicted, the blower outlet seat 24 may be integrally formed with the duct connector 26. Integrating these two elements would reduce the number of components of the ventilation fan 10.

The various components and features described above can be combined in a variety of ways, to provide other non-illustrated embodiments within the scope of the disclosure. As such, it is to be understood that the disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation.

Although the present disclosure has been described in the foregoing description by way of illustrative embodiments thereof, these embodiments can be modified at will, without departing from the spirit, scope, and nature of the subject disclosed.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. In addition, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

In one aspect, a term coupled or the like may refer to being directly coupled. In another aspect, a term coupled or the like may refer to being indirectly coupled. Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The use of the terms “a” and “an” and “the” and “said” and similar references in the context of describing the invention (especially in the context of the following claims) are to be construed to cover both the singular and the plural, unless otherwise indicated herein or clearly contradicted by context. An element proceeded by “a,” “an,” “the,” or “said” does not, without further constraints, preclude the existence of additional same elements. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

We claim:

1. A ventilation fan configured to be positioned adjacent to a room of a building structure to ventilate the room, the ventilation fan comprising:
a fan housing comprising an external wall defining an internal region;
a blower configured to be located in the internal region;
a tongue extending from one of the fan housing and the blower;
a slot defined by one of the fan housing and the blower, the slot configured to receive the tongue to secure the blower to the fan housing.

2. The ventilation fan of claim 1, wherein the blower comprises a scroll and a scroll mounting plate, and the slot is defined in the scroll mounting plate.

3. The ventilation fan of claim 1, further comprising a second tongue and a third tongue.

4. The ventilation fan of claim 1, further defining a second slot and a third slot.

5. The ventilation fan of claim 2, wherein the tongue comprises a proximal end at the fan housing and a distal end spaced from the fan housing, and the scroll mounting plate sits between the tongue distal end and the external wall when the blower is secured to the fan housing.

6. The ventilation fan of claim 2, wherein the scroll mounting plate comprises an ear extending beyond the perimeter of the scroll and the slot is defined in the ear.

7. The ventilation fan of claim 2, wherein the blower is secured to the fan housing by sliding the scroll mounting plate under the tongue.

8. A ventilation fan configured to be positioned adjacent to a room of a building structure to ventilate the room, the ventilation fan comprising:
a fan housing comprising an external wall defining an internal region, a fan housing inlet to the internal region and a fan housing outlet from the internal region;
a blower configured to be located in the internal region, the blower comprising a scroll defining a blower inlet through which the blower is configured to draw air and a blower outlet through which the blower is configured to expel air, the blower outlet defining a blower outlet bevel; and
an outlet seat between the blower outlet and the fan housing outlet, the outlet seat defining an aperture complementing the shape of the blower outlet and defining an outlet seat bevel;
wherein the blower outlet bevel is configured to engage the outlet seat bevel.

9. The ventilation fan of claim 8, wherein the outlet seat bevel complements the blower outlet bevel.

10. The ventilation fan of claim 8, further comprising a duct connector that comprises the outlet seat.

11. The ventilation fan of claim 8, wherein the outlet seat comprises a sleeve configured to extend into the fan housing outlet and the outlet seat bevel extends into the sleeve.

12. The ventilation fan of claim 8, wherein the outlet seat comprises a plate defining the outlet seat aperture and a sleeve extending from the plate at the outlet seat aperture, wherein the sleeve comprises at least part of the outlet seat bevel, and the outlet seat bevel complements the blower outlet bevel.

13. The ventilation fan of claim 12, the plate of the outlet seat is secured to the fan housing.

14. The ventilation fan of claim 8, further comprising a duct connector configured to be secured to the exterior of the fan housing, wherein the outlet seat comprises a sleeve configured to extend into the fan housing outlet and contact the duct connector outside of the fan housing.

15. A method for assembling a ventilation fan having a fan housing defining an internal region, and a blower, the method comprising the steps of:
(a) moving the blower in a first direction toward the fan housing to place the blower into the internal region;
(b) moving the blower a second direction, generally perpendicular to the first direction to secure the blower to the housing.

16. The method of claim 15, wherein the fan housing comprises a tongue and the blower comprises a slot and step (a) further comprises locating the slot around the tongue.

17. The method of claim 16, wherein the tongue extends from the fan housing into the internal region and step (a) further comprises moving the blower in the first direction until the blower contacts the fan housing.

18. The method of claim 16, wherein step (b) further comprises moving the blower in the second direction until the blower is under the tongue.

19. The method of claim 16, wherein the blower comprises an ear in which the slot is defined and wherein step (b) further comprises moving the blower in the second direction until the ear is between the tongue and the fan housing.

20. The method of claim 19, wherein the tongue extends from the fan housing at a tongue proximal end and extends to a tongue distal end and wherein step (b) further comprises moving the blower in the second direction until the ear contacts the tongue proximal end.
